(19) United States
(12) Patent Application Publication
(10) Pub. No.: US 2007/0272532 A1
(43) Pub. Date: Nov. 29, 2007

(54) FACEPLATE ADAPTER FOR MOUNTING A TRADITIONAL-STYLE LOAD CONTROL DEVICE WITH A DESIGNER-STYLE FACEPLATE

(75) Inventors: Michael W. Pessina, Allentown, PA (US); Walter S. Zaharchuk, Macungie, PA (US); Jon M. Keagy, Perkasie, PA (US); Andrew R. Wakefield, Coopersburg, PA (US); Louis G. Rollo, Allentown, PA (US); Greg Edward Sloan, Allentown, PA (US)

Correspondence Address: OSTROLENK FABER GERB & SOFFEN, 1180 AVENUE OF THE AMERICAS, NEW YORK, NY, 100368403, US

(73) Assignee: LUTRON ELECTRONICS CO., INC., Coopersburg, PA (US)

(21) Appl. No.: 11/750,832

(22) Filed: May 18, 2007

Related U.S. Application Data
(60) Provisional application No. 60/808,190, filed on May 24, 2006.

(51) Int. Cl. H01H 13/04

(52) U.S. Cl. 200/333

(57) ABSTRACT

The present invention provides a means for easily ganging together a traditional-style dimmer switch and a designer-style dimmer switch in a multi-gang designer-style faceplate. Specifically, a faceplate adapter for a load control device according to the present invention comprises a front surface, an adapter opening in the front surface, and an attachment post. The front surface defines a first area substantially the same size as a faceplate opening of a designer-style faceplate. The adapter opening defines a second area substantially the same size as a faceplate opening of a traditional-style faceplate. The attachment post allows the adapter to be secured to the load control device.

### RELATED APPLICATIONS

This application claims priority from commonly-assigned U.S. Provisional Patent Application Ser. No. 60/808,190, filed May 24, 2006, having the same title as the present invention, the entire disclosure of which is hereby incorporated by reference.

### BACKGROUND OF THE INVENTION

1. Field of the Invention

The present invention relates to load control devices for controlling the amount of power delivered to an electrical load, specifically a traditional-style dimmer switch having a faceplate adapter to allow the dimmer switch to be mounted with a designer-style faceplate.

2. Description of the Related Art

A conventional wall-mounted load control device is mounted to a standard electrical wall box and is coupled between a source of alternating-current (AC) power (typically 50 or 60 Hz line voltage AC mains) and an electrical load. Standard load control devices, such as dimmers and motor speed controls, use one or more semiconductor switches, such as triacs or field effect transistors (FETs), to control the current delivered to the load, and thus, the intensity of the lighting load or the speed of the motor. The semiconductor switch is typically coupled in series between the source and the lighting load. Using a phase-control dimming technique, the dimmer renders the semiconductor switch conductive for a portion of each line half-cycle to provide power to the lighting load, and renders the semiconductor switch non-conductive for the other portion of the line half-cycle to disconnect power from the load.

Wall-mounted load control devices typically include a user interface having a means for adjusting the power delivered to the load, such as a linear slider, a rotary knob, or a rocker switch. As shown in FIG. 1, a traditional-style dimmer switch 10 is designed to be mounted with a traditional-style faceplate (which has an opening sized to receive a typical toggle switch). Alternatively, the user interface of a designer-style dimmer switch 20 is operable to be received in the opening of an industry-standard designer-style faceplate as shown in FIG. 2. Per standards set by the National Electrical Manufacturers Association (NEMA), the opening of a traditional-style faceplate has a length of 0.925″ and a width of 0.401″ (NEMA Standards Publication No. WD6, 2001, p. 7), while the opening of a designer-style faceplate has a length of 2.630″ and a width of 1.310″ (NEMA Standards Publication No. WD6, 2001, p. 5).

It is desirable to gang together the traditional-style dimmer switch 10 and the designer-style dimmer switch 20, i.e., to install the traditional-style dimmer switch and the designer-style dimmer switch next to each other in a two-gang wallbox. Prior art faceplates, for example, the faceplate 30 shown in FIG. 3, allow the traditional-style dimmer switch 10 and the designer-style dimmer switch 20 to be ganged together. However, such faceplates are often custom-made and are thus difficult to purchase. Further, the faceplate shown in FIG. 3 does not provide an attractive aesthetic.

Therefore, it is desirable to gang together the traditional-style dimmer switch 10 and the designer-style dimmer switch 20 using a multi-gang designer-style faceplate 40 as shown in FIG. 4. Thus, there is a need for a means for easily ganging together a traditional-style dimmer switch and a designer-style dimmer switch in a multi-gang designer-style faceplate.

### SUMMARY OF THE INVENTION

According to the present invention, a faceplate adapter for a load control device comprises a front surface, an adapter opening in the front surface, and an attachment post. The front surface defines a first area substantially the same size and shape as a faceplate opening of a designer-style faceplate. The adapter opening defines a second area substantially the same size as a faceplate opening of a traditional-style faceplate. The attachment post allows the adapter to be secured to the load control device.

The present invention further provides a traditional-style load control device having a faceplate adapter to allow the load control device to be mounted with a designer-style faceplate. Specifically, the load control device comprises a designer-style faceplate having a first opening defining a first area, an adapter having a periphery defining the first area, and a user interface. The adapter is operable to be received in the first opening of the designer-style faceplate and has a second opening defining a second area larger than the first area. The user interface is operable to be received in the second opening of the adapter. Preferably, the load control device further comprises a yoke for attaching the load control device to an electrical wallbox. The yoke comprises an attachment opening and the adapter comprises an attachment post operable to be received in the attachment opening to secure the adapter to the yoke.

Other features and advantages of the present invention will become apparent from the following description of the invention that refers to the accompanying drawings.

### BRIEF DESCRIPTION OF THE DRAWINGS

FIG. 1 is a perspective view of a traditional-style dimmer switch;

FIG. 2 is a perspective view of a designer-style dimmer switch;

FIG. 3 is a faceplate for ganging the traditional-style dimmer switch of FIG. 1 with the designer-style dimmer switch of FIG. 2;

FIG. 4 is a multi-gang designer-style faceplate;

FIG. 5 is a perspective view of a traditional-style dimmer switch according to a first embodiment of the present invention;

FIG. 6A is a front perspective of an adapter of the dimmer switch of FIG. 5;

FIG. 6B is a rear perspective view of the adapter of FIG. 6A;

FIG. 6C is a partial enlarged view of a lower post of the adapter of FIG. 6B;

FIG. 7 is an exploded view of the dimmer switch of FIG. 5;

FIG. 8 is a perspective view of a traditional-style dimmer switch 200 according to a second embodiment of the present invention;

FIG. 9A is a front perspective of an adapter of the dimmer switch of FIG. 8;

FIG. 9B is a rear perspective view of the adapter of FIG. 9A; and

FIG. 10 is an exploded view of the dimmer switch of FIG. 8.

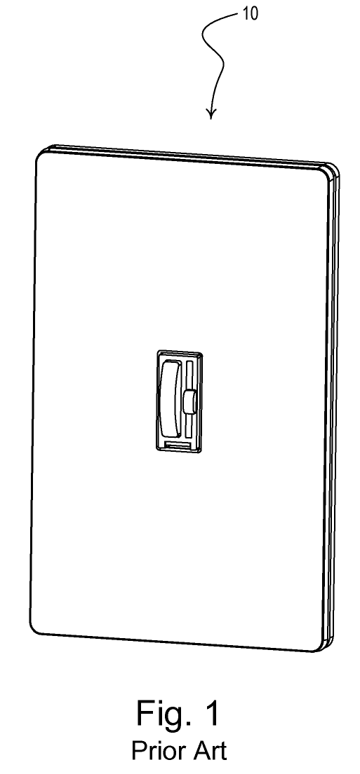

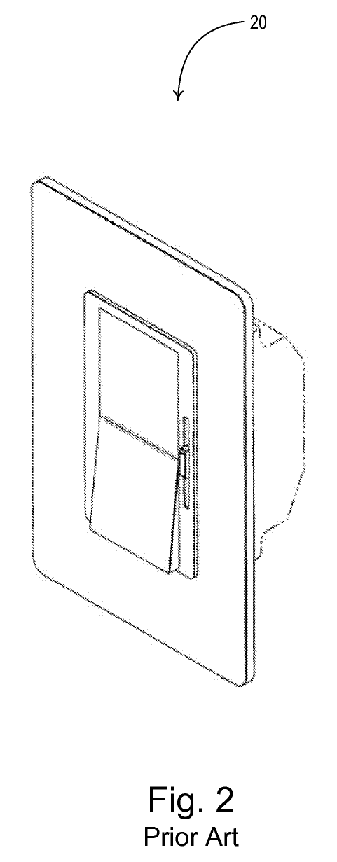

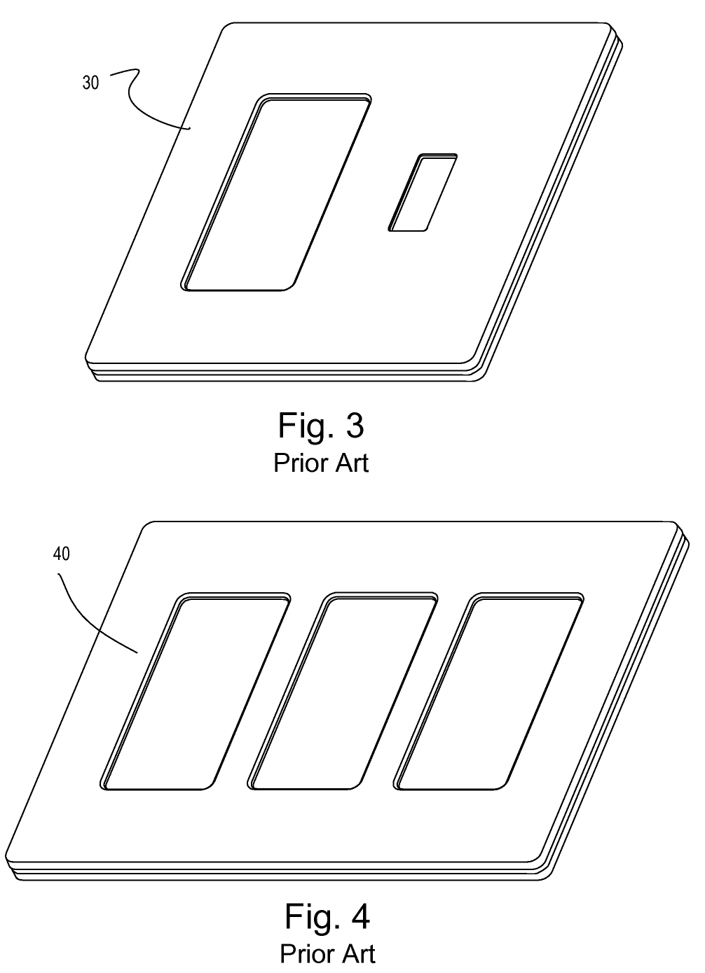

### DETAILED DESCRIPTION OF THE INVENTION

The foregoing summary, as well as the following detailed description of the preferred embodiments, is better understood when read in conjunction with the appended drawings. For the purpose of illustrating the invention, there is shown in the drawings an embodiments that is presently preferred, in which like numerals represent similar parts throughout the several views of the drawings, it being understood, however, that the invention is not limited to the specific methods and instrumentalities disclosed.

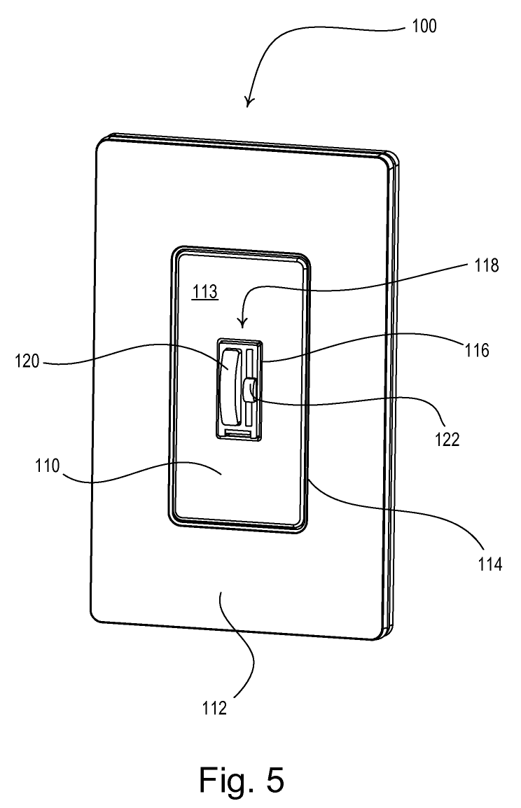

FIG. 5 is a perspective view of a traditional-style dimmer switch 100, i.e., a traditional-style load control device, according to a first embodiment of the present invention. The dimmer switch 100 comprises an adapter 110 allowing the dimmer switch to be mounted with a designer-style faceplate 112. The adapter 110 has a front surface 113 defining a first area. The designer-style faceplate 112 has a faceplate opening 114 substantially the same size as the first area, such that the faceplate opening 114 is operable to receive the adapter 110. The adapter 110 has an adapter opening 116 defining a second area. Preferably, the first and second areas are defined by the NEMA standards for a designer-style faceplate opening and a traditional-style faceplate opening, respectively. In other words, the first area has a length of approximately 2.630″ and a width of approximately 1.310″, while the second area has a length of approximately 0.925″ and a width of approximately 0.401″.

The dimmer switch 100 further comprises a user interface 118. The user interface 118 has a toggle button 120 to allow a user to toggle a connected lighting load (not shown) between on and off. The user interface 118 also includes an intensity adjustment actuator 122, i.e., a slider control, for allowing the user to adjust the intensity of the connected lighting load. The user interface 118 is operable to be received in the adapter opening 116.

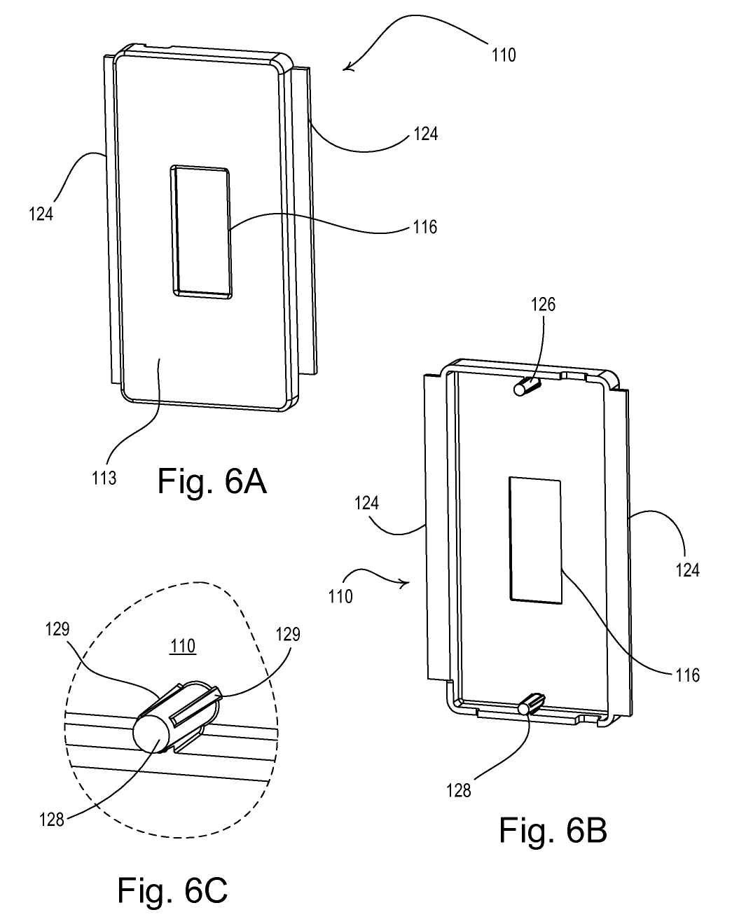

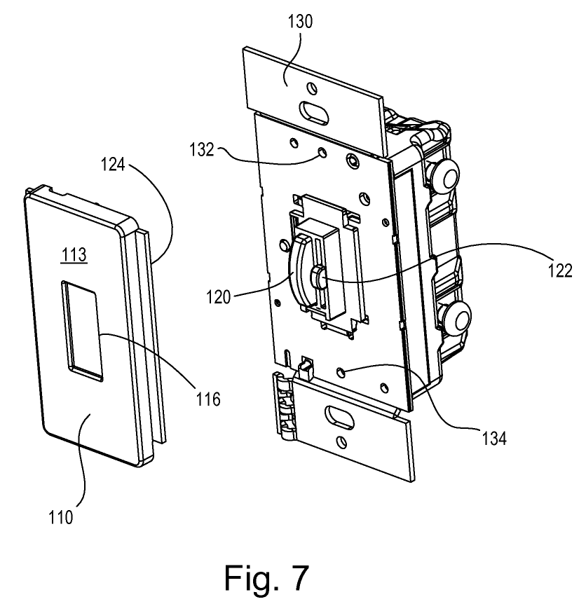

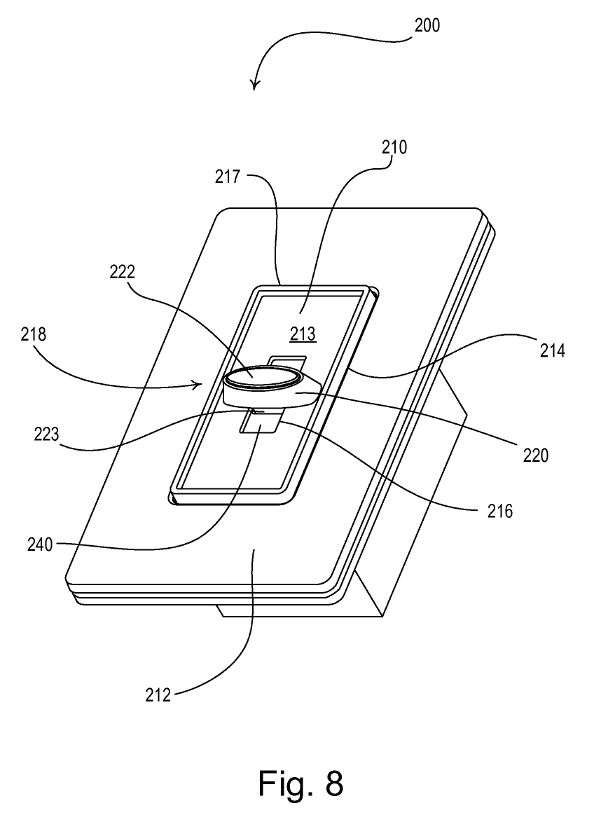

FIG. 6A is a front perspective view and FIG. 6B is a rear perspective view of the adapter 110. The adapter 110 comprises two flanges 124 on the left and right sides to allow the adapter to be captured between the designer-style faceplate 112 and a yoke 130 (FIG. 7) of the dimmer switch 100. The adapter 110 further comprises an upper post 126 and a lower post 128 for fixed attachment to the yoke 130. The upper and lower posts 126, 128 hold the adapter 110 to the yoke 130 of the dimmer switch 100 while the faceplate 112 is being installed on the dimmer switch. The upper and lower posts 126, 128 also allow for proper alignment of the adapter 110 in the opening 114 of the designer-style faceplate 112.

FIG. 6C is a partial enlarged view of the lower post 128. The lower post 128 comprises a plurality of crush ribs 129 extending lengthwise along the post 128 and spaced circumferentially around the post 128. The upper post 126 comprises an identical structure of crush ribs 129 as the lower post 128.

FIG. 7 is an exploded view of the dimmer switch 100. The yoke 130 allows for attachment of the dimmer switch 100 to an electrical wallbox. The yoke 130 comprises upper and lower attachment openings 132, 134 for receipt of the upper and lower posts 126, 128, respectively. The upper and lower attachment openings 132, 134 are sized such that the crush ribs 129 contact the attachment openings and are deformed when the adapter 110 is installed on the yoke 130. Accordingly, the adapter 110 is held in place by contact between the crush ribs 129 and the attachment openings 132, 134.

With the faceplate adapter 110 attached, the traditional-style dimmer switch 110 may be installed next to a designer-style load control device in a standard multi-gang designer-style faceplate (e.g., such as the faceplate 40 of FIG. 4). Accordingly, the installation of the traditional-style dimmer switch 110 having the faceplate adapter 110 and the designer-style load control device in combination with the standard multi-gang designer-style faceplate provides a clean, consistent appearance.

FIG. 8 is a perspective view of a traditional-style dimmer switch 200 according to a second embodiment of the present invention. The dimmer switch 200 comprises an adapter 210 operable to be received in a faceplate opening 214 of a designer-style faceplate 212. The adapter 210 has a front surface 213 defining a first area and an adapter opening 216 defining a second area. The area of the faceplate opening 214 is substantially the same as the first area, such that faceplate opening is operable to receive the adapter 210. The adapter 210 further comprises a rim 217 surrounding the front surface 213 of the adapter 210.

A user interface 218 of the dimmer switch 200 comprises a slider control that is operable to be provided through the opening of a traditional-style faceplate, i.e., the adapter opening 216. The user interface 218 includes a knob 220 that has a pushbutton 222 and is coupled to a potentiometer (not shown) inside the dimmer switch 200 via a post 223. The post 223 has a width substantially the same as the width of the second opening 116. Movement of the knob 220 along the length of the adapter opening 116 adjusts the intensity of a connected lighting load (not shown). Actuation of the pushbutton 222 toggles the connected lighting load between on and off. A slider cover 240 is located behind the adapter 210. The slider cover 240 prevents debris and external objects from contacting the potentiometer inside the dimmer switch 200 as well as providing an attractive aesthetic. The post 223 extends through the slider cover 240, such that the slider cover 240 moves as the knob 222 moves.

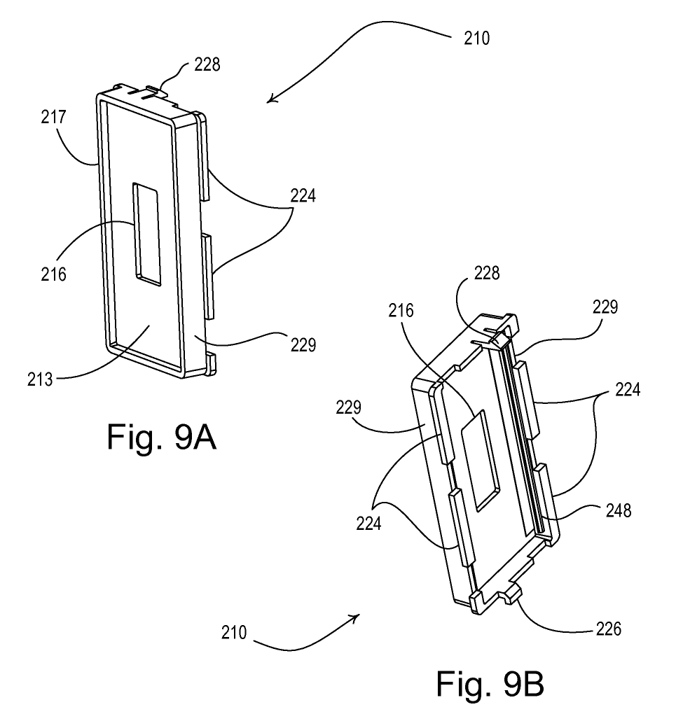

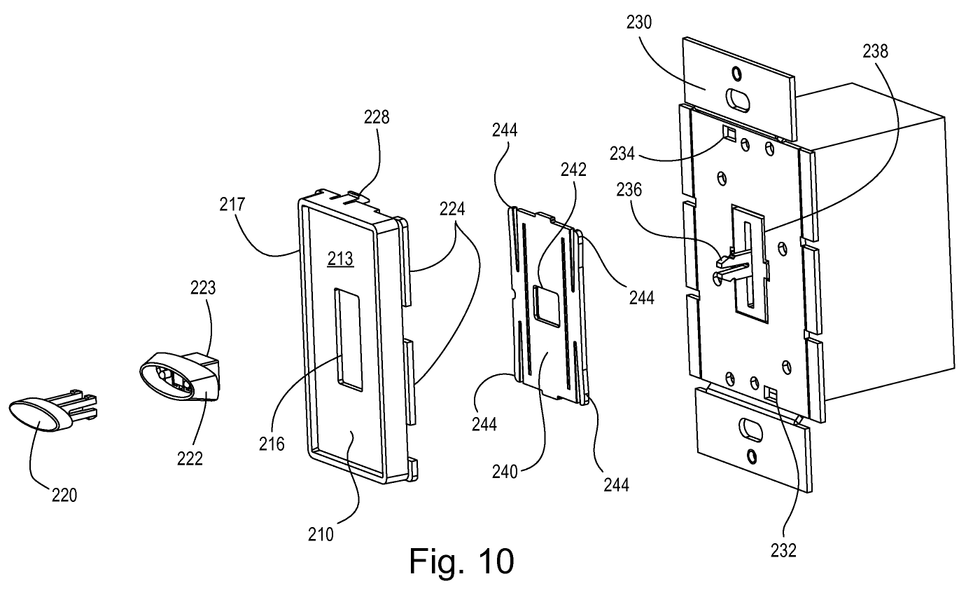

FIG. 9A is a front perspective view and FIG. 9B is a rear perspective view of the adapter 210. The adapter 210 comprises flanges 224 on the left and right sides to allow the adapter to be captured between the designer-style faceplate 212 and a yoke 230 (FIG. 10) of the dimmer switch 200. The adapter 210 comprises attachment posts, e.g., an attachment clip 226 and a snap tab 228, for fixed attachment to the yoke 230. The adapter 210 further comprises support rails 248 on the left and right side walls 229 of the adapter 210. The support rails 248 support the slider cover 240 as will be described in greater detail below.

FIG. 10 is an exploded view of the dimmer switch 200. The yoke 230 allows for attachment of the dimmer switch 200 to an electrical wallbox. The yoke 230 comprises a first attachment opening 232 and a second attachment opening 234 for receipt of the attachment clip 226 and the snap tab 228 of the adapter 210, respectively. A potentiometer post 236 extends through a central opening 238 in the yoke 230.

The post 223 of the knob 222 extends through the adapter opening 216 and a slider opening 242 of the slider cover 240 to engage the potentiometer post 236. The slider opening 242 has a length and a width substantially equal to the length and the width of the post 223. The slider cover 240 has a plurality of arms 244 that allow the slider cover to rest on the support rails 248 and allow for movement of the slider cover such that the knob 222 is operable to move the length of the adapter opening 216.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A load control device comprising:
a designer-style faceplate having a first opening defining a first area;
an adapter having a periphery defining the first area and operable to be received in the first opening of the designer-style faceplate, the adapter having a second opening defining a second area smaller than the first area; and
a user interface operable to be received in the second opening of the adapter.

2. The load control device of claim 1, further comprising:
a yoke for attaching the load control device to an electrical wallbox, the yoke comprising an attachment opening;
wherein the adapter comprises an attachment post operable to be received in the attachment opening to secure the adapter to the yoke.

3. The load control device of claim 2, wherein the attachment post comprises a snap tab operable to snap into the attachment opening of the yoke.

4. The load control device of claim 3, wherein the adapter further comprises an attachment clip.

5. The load control device of claim 2, wherein the attachment post comprises a plurality of crush ribs extending lengthwise along the attachment post and spaced circumferentially around the attachment post.

6. The load control device of claim 5, wherein the crush ribs are sized such that the crush ribs contact the attachment opening and are deformed when the adapter is installed on the yoke.

7. The load control device of claim 2, wherein the user interface comprises a toggle button.

8. The load control device of claim 2, wherein the user interface comprises a slider actuator.

9. The load control device of claim 2, wherein the second area is substantially the same size as a faceplate opening of a traditional-style faceplate.

10. A faceplate adapter for a load control device, the adapter comprising:
a front surface defining a first area substantially the same size as a faceplate opening of a designer-style faceplate;
an adapter opening in the front surface, the adapter opening defining a second area substantially the same size as a faceplate opening of a traditional-style faceplate; and
an attachment post for securing the adapter to the load control device.

11. The faceplate adapter of claim 9, wherein the attachment post comprises a snap tab.

12. The faceplate adapter of claim 10, wherein the adapter further comprises an attachment clip.

13. The faceplate adapter of claim 9, wherein the attachment post comprises a plurality of crush ribs extending lengthwise along the attachment post and spaced circumferentially around the attachment post.

14. The faceplate adapter of claim 12, wherein the adapter is operable to be installed on a yoke of the load control device, and the crush ribs are sized such that the crush ribs contact an attachment opening of the yoke and are deformed when the adapter is installed on the yoke.
